(19) United States
(12) Patent Application Publication
(10) Pub. No.: US 2007/0088619 A1
(43) Pub. Date: Apr. 19, 2007

(54) MOULDING DECORATING KIT AND ONLINE ORDERING SYSTEM

(75) Inventors: Elizabeth Kirwan, Jacksonville, FL (US); Susan Stith, WESTMINSTER, MD (US)

Correspondence Address: MARK YOUNG, P.A., 12086 FORT CAROLINE ROAD, UNIT 202, JACKSONVILLE, FL, 32225, US

(73) Assignee: DECORATE YOUR DOORS! INC., Jacksonville, FL (US)

(21) Appl. No.: 11/467,904

(22) Filed: Aug. 28, 2006

Related U.S. Application Data
(60) Provisional application No. 60/596,057, filed on Aug. 27, 2005.

(51) Int. Cl. G06Q 30/00

(52) U.S. Cl. 705/26

(57) ABSTRACT

An on-line ordering and/or fulfillment system for a moulding decorating kit is provided. The system includes a user interface with a control for specifying a design, a control for selecting a moulding type, a control for specifying a substrate size, and a module for determining the number of pieces of moulding and the length of each piece of moulding for the specified design and substrate size. The moulding kit includes a plurality of moulding pieces. The moulding pieces are primed and of a determined type of moulding. The pieces have joint ends. Attachment means such as nails with two or more nail starter holes per piece, adhesives or bonding agents are also provided. The pieces may be configured to form the determined design on a substrate having the specified substrate size. The kit may also include filler, and installation instructions. Optionally, a measuring and alignment tool may be provided to engage a substrate corner and facilitate marking a starting point.

### RELATED APPLICATION

This application claims the benefit of priority of U.S. Provisional Application 60/596,057, filed Aug. 27, 2005, the entire contents of which are incorporated herein.

### FIELD OF THE INVENTION

This invention generally relates to moulding decorating kits, and more particularly, to a kit for decorating a substrate such as a door with moulding and an online ordering system for such kits.

### BACKGROUND

Many facilities (e.g., homes, apartments, condominiums and offices) are equipped with unadorned surfaces such as flat panel doors and plain walls. While such doors and walls are relatively inexpensive, they lack the character and depth of a decorative three-dimensional surface. To enhance the appearance of the doors and walls an occupant may decide to add decorative moulding.

Unfortunately, the conventional process of adding decorative moulding to a surface such as a door or wall is tedious, fraught with risk and often results in an inferior product. The process typically entails calculating how much moulding will be needed, allowing substantial excess for inevitable waste. Then the moulding is primed, mitre cut and fastened to the surface. Often, the primed moulding must be sanded to remove drip marks. Additionally, it is often difficult to achieve a desired angle by mitre cutting, especially if a layperson is making the cuts. Improper fastening often results in skewed and/or split moulding.

Accordingly, a need exists for a system and method that provide an all-inclusive kit for decorating a structure such as a door with moulding. Preferably, the system and method require a few simple input values to determine the contents of the kit for achieving a desired moulding decoration.

The invention is directed to overcoming one or more of the problems and solving one or more of the needs as set forth above.

### SUMMARY OF THE INVENTION

To solve one or more of the problems set forth above, in an exemplary implementation of the invention, an on-line ordering and/or fulfillment system for a moulding decorating kit is provided. A door moulding kit is also provided. Optionally, a measuring and alignment tool may be provided in the kit to engage a substrate corner and facilitate marking a starting point.

One exemplary on-line ordering and fulfillment system for a moulding decorating kit includes a user interface, with a control for specifying a design, a control for selecting a moulding type, and a control for specifying a substrate size. The system also includes a module for determining a number of pieces of moulding and a length of each piece of moulding for a specified design and substrate size. The control for specifying a substrate size may include a dropdown list or a form field into which a user may enter the dimensions of a substrate. The control for specifying a design may include a plurality of user-selectable design images and/or names, a plurality of user-selectable images of moulding types and/or names of moulding types.

An exemplary moulding kit for a determined design, moulding type and substrate size is also provided. The kit includes a plurality of moulding pieces. The pieces are primed, of a determined type of moulding, and have joint ends. The moulding pieces are configured to form the determined design on a determined substrate having a determined size. The kit may also include attachment means, filler and installation instructions. Each of the plurality of moulding pieces includes a back surface. The attachment means may comprise a plurality of nail starter holes in each of the plurality of moulding pieces, and at least one nail per nail starter hole. Alternatively, the attachment means may comprise an adhesive (e.g., a pressure sensitive adhesive covered with a releasable backing strip) applied to the back surface of each of the plurality of moulding pieces. Alternatively, a bonding agent may be applied to the back surface of each of the plurality of moulding pieces for attaching them to the substrate. The plurality of moulding pieces may be comprised of a material from the group consisting of wood, plastic and foam. Each of the plurality of moulding pieces includes an identifier. The identifier may be a distinguishing piece identifier and/or a distinguishing end identifier. The joint ends may be mitre, butt, butterfly, dovetail, finger, lap, mortise and tenon, rabbet, scarf, splice, or tongue and groove joints.

A measuring and alignment tool may also be provided in the kit. The tool may comprise a planar surface, a pair of intersecting raised perpendicular edges extending from a side of the planar surface, wherein the distance from one of the raised perpendicular edges to an opposite edge equals a determined first distance, and the distance from the other of the raised perpendicular edges to an opposite edge equals a determined second distance.

### BRIEF DESCRIPTION OF THE DRAWINGS

The foregoing and other aspects, objects, features and advantages of the invention will become better understood with reference to the following description, appended claims, and accompanying drawings, where:

FIG. 1 provides a high level flowchart of an exemplary ordering process in accordance with principles of the invention; and

FIG. 2 provides plan views of exemplary door designs to illustrate principles of the invention; and

FIG. 3 provides an exemplary user interface for inputting specifications for a kit and purchasing the kit in accordance with principles of the invention; and

FIG. 4 provides a high level flowchart of an exemplary order fulfillment process in accordance with principles of the invention; and

FIG. 5 provides a high level flowchart of an exemplary installation process in accordance with principles of the invention; and

FIG. 6 provides a high level block diagram of an exemplary kit in accordance with principles of the invention;

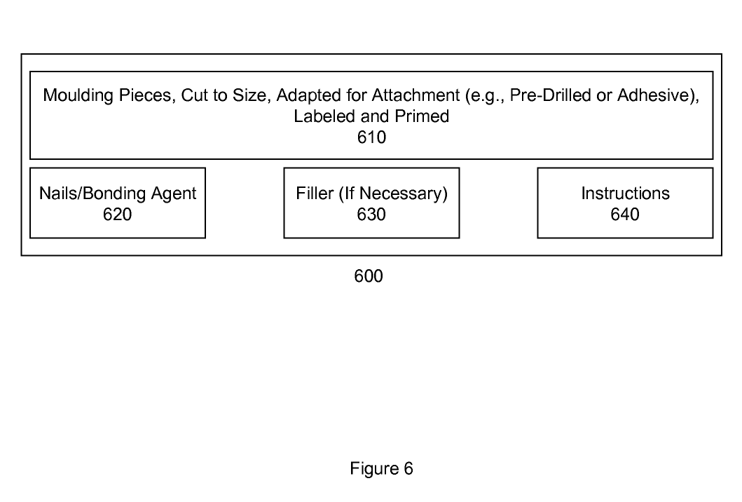

FIGS. 7A and 7B conceptually illustrate an exemplary optional measuring and alignment device for use with a kit in accordance with principles of the invention; and

FIG. 8 conceptually illustrates an exemplary piece of labeled moulding for use with a kit in accordance with principles of the invention.

Those skilled in the art will appreciate that the figures are not intended to be drawn to any particular scale; nor are the figures intended to illustrate every embodiment of the invention. The invention is not limited to the exemplary embodiments depicted in the figures or the shapes, layouts, relative sizes, textual content, exemplary pricing, ornamental aspects or proportions shown in the figures.

### DETAILED DESCRIPTION

In an exemplary implementation of the invention, a system and methodology are provided for receiving and fulfilling an order for an all-inclusive moulding decoration kit. The kit provides all of the materials required for installation of the moulding without steps that are conducive to error such as cutting, drilling or priming. Additionally, an optional measuring device may be provided to facilitate proper alignment of the moulding pieces.

The principles of the invention are not limited to any particular type of substrate. The invention may be applied to any substrate suitable for decorating with moulding. Not limiting examples include doors, walls, ceilings and furniture.

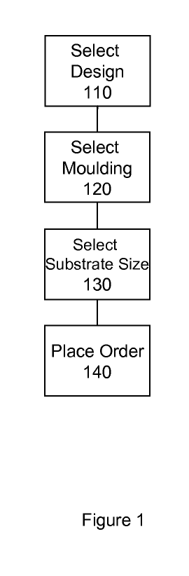

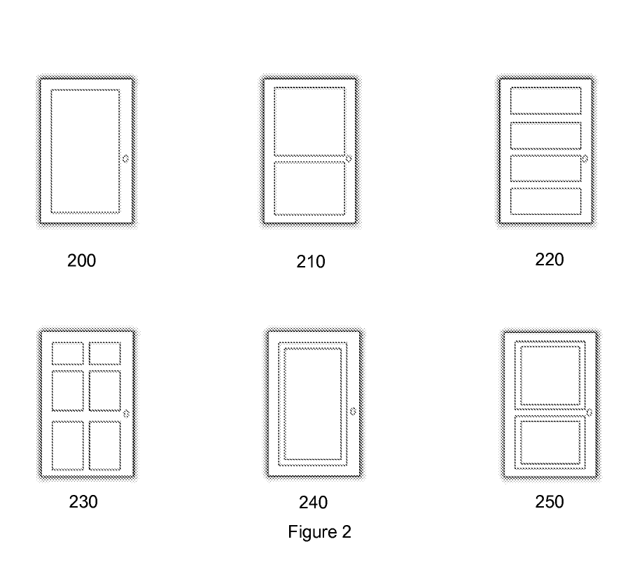

Referring now to FIG. 1, a high-level flowchart of an exemplary ordering process in accordance with principles of the invention is shown. An initial step 110 entails selecting a design. Designs may be selected from a plurality of available designs or custom-designed. By way of example and not limitation, the design may be comprised of single rectangle 200, double rectangle 210, four rectangles 220, six rectangles 230, single within a single concentric rectangle 240, or double within double concentric rectangles 250, as conceptually shown in FIG. 2, or some other configuration. The designs may be selected from a web page displayed on a networked computer, a kiosk, a catalog or some other means of presentation and selection. Upon completion of this step, the desired design is known.

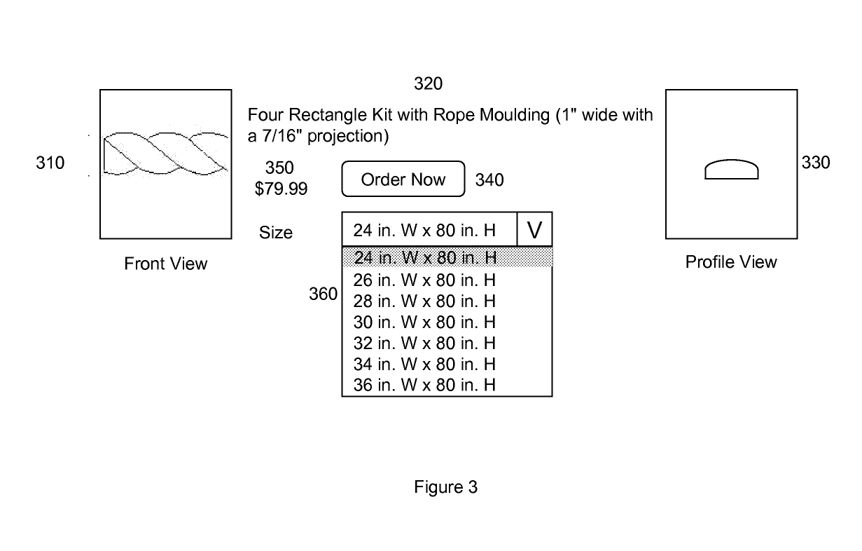

Another step 120 entails selecting the type of moulding to be used. This step 120 may be performed before or after selecting a design 110. The moulding may be selected from a web page displayed on a networked computer, a kiosk, a catalog or some other means of presentation and selection. The invention is not limited to any particular moulding design. Instead, the moulding may feature any design now known or hereafter developed that is suitable for mounting to the desired surface. By way of illustration and not limitation, mouldings having any design (such as the rope moulding design depicted in FIG. 3) may be utilized.

After the design and moulding have been selected, a substrate size (e.g., a door or wall size) is specified, as in step 130. Alternatively, the size may be specified before either or both of the previous steps. The size may be specified via a web page displayed on a networked computer, a kiosk, a printed form or some other means of specification. Illustratively, FIG. 3 conceptually shows an exemplary web-based user interface for specifying a door size and placing an order. The size may be selected from a dropdown list 360, entered into a form field or input using any other input means.

In addition to providing a means for specifying a size, the exemplary user interface in FIG. 3 describes the design 320. The interface also displays relevant images, such as front 310 and profile 330 views of the moulding. Other images that may be displayed in addition to or in lieu of the front 310 and profile 330 optionally include an image of a door with the selected moulding installed in the configuration of the selected design.

After the design and moulding have been selected, and the size (e.g., a door or wall size) has been specified, an order may be placed as in step 140. The exemplary user interface includes purchasing information and functions, such as a price and an ordering button 340 linked to an on-line purchasing web page. The order may be placed online, by telephone, facsimile or any other manner of order placement.

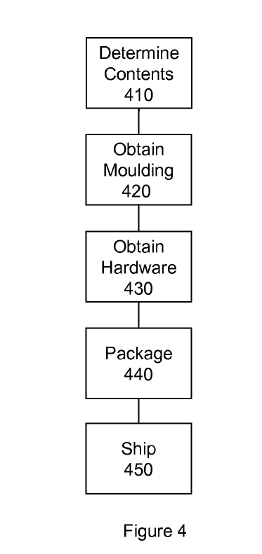

Referring now to FIG. 4, a high-level flowchart of an exemplary order fulfillment process in accordance with principles of the invention is provided. In a preferred implementation, the exemplary process entails providing a kit containing items in fulfillment of an order. As an initial step 410, the contents of the kit are determined. The contents of an exemplary kit 600 preferably include moulding pieces, cut or formed to size, adapted for attachment, labeled and primed 610; nails/bonding agent 620; filler 630 and installation instructions 640. Depending upon the type of moulding, filler 630 may be included or omitted from the kit. The number of pieces of moulding will depend upon the selected design. The length of each piece of moulding will depend upon the selected design and the specified size. The ordering and/or fulfillment systems may include a module (i.e., a means) for determining the required pieces of moulding based upon the order specifications. Illustratively, the module may calculate the lengths of moulding, look-up the appropriate lengths from a table, or determine the required pieces in some other manner. For example, a single rectangle kit may be provided for a 24 inch by 80-inch door. Such a kit may include moulding for a single rectangle design of 16 inches by 72 inches, i.e., two 16-inch pieces and two 72-inch pieces. To facilitate shipping, long pieces, such as 72-inch pieces, may be divided into two or more pieces.

After the moulding pieces are determined, they are obtained 420. The moulding may be prepared in advance and stored in inventory. Alternatively, the moulding may be prepared upon placement of an order. In an exemplary implementation, preparation of the moulding entails cutting or otherwise producing the required pieces and forming joints for abutting ends, priming the pieces and adapting the moulding for attachment such as by drilling starter holes for nailing the pieces. These steps of cutting, priming and adapting may be performed in various orders within the scope of the invention.

The invention is not limited to wood mouldings. By way of example and not limitation, cast or extruded plastic or foam mouldings may be utilized within the scope of the invention. Illustratively, a low density, closed cell, resilient foam may be utilized. Such flexible plastic foams include polyethylene, rubber latex, polypropylene, polyurethane, polyvinyl chloride or polyolefin flexible plastic foam.

Each piece of moulding is preferably prepared for painting by applying a primer. The primer may be oil, lacquer or water based. It seals the unpainted surfaces to prevent covering coats of paint soaking in. The primer may be applied by spraying, dipping or brushing.

Each piece of moulding is preferably prepared for attachment to a substrate (e.g., a wall or door). By way of example and not limitation, wood moulding may be pre-drilled. Holes may be made at determined locations to facilitate fastening the moulding to a door with nails, without splitting. The holes should have a diameter about the same or slightly smaller than the diameter of the nails that will be used to fasten the moulding.

In the case of plastic or foam moulding, adhesives and/or bonding agents may be utilized to secure the moulding to a substrate. Thus, in lieu of providing starter holes for nails, the back of the moulding may provide a flat surface to which glue or another bonding agent may be applied for securing the moulding to a substrate. Alternatively, a pressure sensitive adhesive may be applied to the back of the moulding and covered with a releasable backing strip. Removal of the releasable backing strip exposes the adhesive allowing the moulding to be secured to the substrate.

Each piece of moulding is cut or produced to provide a determined joint. Illustratively, for a mitre joint, the ends of two pieces of abutting moulding may be cut at a 45-degree angle. A mitre joint may used for appearance sake, as the joint conceals the exposed end grain of both pieces of moulding. The mitres can be cut using a saw with a guide or jig configured to produce an accurate clean cut.

However, the invention is not limited to mitre joints or any other particular joint or method of joining moulding sections together. While mitre and butt joints are preferred, other suitable joints known in the art include butterfly, dovetail, finger (box), lap, mortise and tenon, rabbet, scarf (scarph), splice, and tongue and groove joints. Any joint suitable for us with abutting moulding sections may be utilized without departing from the scope of the invention.

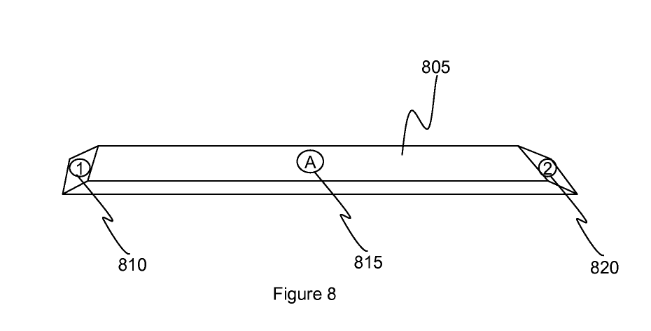

Each piece of moulding and/or each free end may also labeled (i.e., include one or more identifiers), for example, as conceptually illustrated in FIG. 8. By way of example and not limitation, a sticker or other marking with labeling indicia may be applied to the back of each piece and/or at or adjacent to each free end. The labeling indicia may comprise one or more alphanumeric characters, symbols, colors or other means for uniquely identifying a piece and/or each end of a piece. Thus, each piece of moulding may include a distinguishing piece identifier, and each end of each piece may include a distinguishing end identifier. The exemplary moulding piece 805 conceptually shown in FIG. 8 includes a label to uniquely identify the piece 815 and labels 810, 820 to identify each end. The labeling indicia may correspond to installation instructions. Thus, an installer may readily identify each piece and each end of each piece for installation in accordance with installation instructions. A preferred order of installation of moulding pieces may also be defined referring to such labels.

The fulfillment process also entails obtaining the hardware and accessories, as in step 430. In an exemplary implementation, the hardware includes the nails and filler for wood moulding, and adhesive or bonding agent for plastic or foam moulding. Optionally, filler may be provided for plastic or foam moulding. The nails are used to fasten the pre-drilled pieces of moulding to a substrate without splitting. Likewise, adhesives or bonding agents may be used to secure plastic or foam moulding pieces to a substrate. The filler is used to fill and conceal countersunk nail holes and any noticeable gaps between abutting joints. Other hardware and accessories, such as installation tools, glue, paint, stain and decorative door hardware (e.g., doorknobs) may optionally be included.

The pieces of moulding 610, nails/bonding agent 620, filler 630 and installation instructions 640, are packaged for shipping, as in step 440. The packaged contents comprise the kit. By way of example and not limitation, the contents may be packaged in a polytube bag. Small items, such as nails and filler may be contained in a separate smaller bag or some other suitable container(s) and then placed within the polytube bag with the moulding. The kit may be enclosed in a box or some other container for shipping. The kit is preferably protected in the shipping box to avoid damage (e.g., scratches to the moulding) during shipping. Illustratively, bubble wrap, packing paper and cushioning may be utilized to protect the kit.

Next, the packaged kit may be shipped or made available to a consumer via any suitable delivery method, as in step 450. Upon receipt of a kit, a consumer may install the moulding.

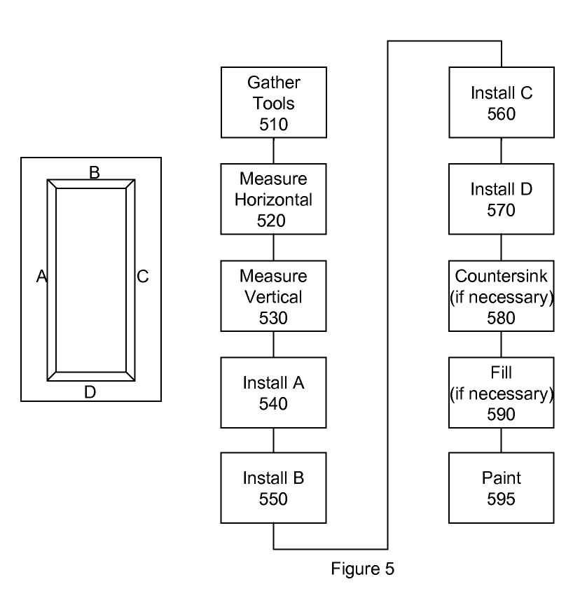

Referring now to FIG. 5, a high-level flowchart of an exemplary installation process in accordance with principles of the invention is provided. Certain basic tools required for proper installation, such as a ruler, level, pencil and a hammer, should be gathered to commence installation, as in step 510. All other supplies, except paint, are included in the exemplary kit.

Once the tools are gathered, horizontal 520 and vertical 530 measurements are made to determine a starting point for installing the moulding. The starting point should be marked with a light visible pencil mark on the door. Illustratively, a starting point may be determined by measuring across 4 inches from the top left corner (along the top edge) of the door and making a faint pencil mark. Next, the installer measures straight down 4 inches from the mark made in accordance with the previous sentence. Again, a faint pencil mark should be made. This mark, 4 inches across from the left side of the door and 4 inches down from the top of the door, may be the starting point for the first piece of moulding.

A first piece of moulding (e.g., a piece of moulding labeled A) for the exemplary design shown in FIG. 5 will be installed parallel to the vertical (side) edges of the substrate (i.e., in this example a door) with the outside upper corner of the piece on the starting point, as in step 540. Piece A may be installed using nails (e.g., finishing nails), bonding agent or adhesive as provided in the kit. While installing, the installer should check that the outside upper corner of piece A is on the starting point, and the moulding is parallel to the vertical edge of the door. A level and ruler may be utilized to ensure that the first piece of moulding is parallel to the edge of the door. If the door is level, Piece A should also be vertical.

A second piece of moulding (e.g., a piece of moulding labeled B) for the exemplary design shown in FIG. 5 will be installed parallel to the horizontal (top and bottom) edges of the door with the outside upper corner of the piece on the starting point, as in step 550. Piece B may be installed using nails (e.g., finishing nails), bonding agent or adhesive as provided in the kit. While installing, the installer should check that the outside upper corner of piece B is on the starting point and the joint end of Piece A is flush against the corresponding joint end of Piece B. The installer should also check that Piece B of the moulding is parallel to the horizontal edge of the door and perpendicular to Piece A. A level and ruler may be utilized. If the door is level, Piece B should also be horizontal.

A third piece of moulding (e.g., a piece of moulding labeled C) for the exemplary design shown in FIG. 5 will be installed parallel to the vertical (side) edges of the door with a joint end of Piece C flush against a corresponding joint end of Piece B, as in step 560. Piece C may be installed using nails (e.g., finishing nails), bonding agent or adhesive as provided in the kit. While installing, the installer should check that the joint end of Piece C is flush against the corresponding joint end of Piece B. The installer should also check that Piece C is parallel to the vertical edge of the door and perpendicular to Piece B. A level and ruler may be utilized. If the door is level, Piece C should also be vertical.

A fourth piece of moulding (e.g., a piece of moulding labeled D) for the exemplary design shown in FIG. 5 will be installed parallel to the horizontal (top and bottom) edges of the door with a joint end of Piece D flush against a corresponding joint end of Piece C and another joint end of Piece D flush against a corresponding joint end of Piece A, as in step 570. Piece D may be installed using nails (e.g., finishing nails), bonding agent or adhesive as provided in the kit. While installing, the installer should check that the joint ends of piece D are flush against the corresponding joint ends of Piece A and Piece C. The installer should also check that Piece D of the moulding is parallel to the horizontal edge of the door and perpendicular to Pieces A and C. A level and ruler may be utilized. If the door is level, Piece D should also be horizontal.

Next, if nails were used, all nail heads should be countersunk, as in step 580. To countersink, an installer may use another nail or a countersink nail set tool and a hammer to tap the installed nail head slightly below the surface of the moulding. Countersinking will conceal the nail heads and prevent scratching and snagging by the nail head.

All countersunk nail holes should then be filled using filler, such as wood putty, provided in the kit, as in step 590. The filler should be allowed to dry and sanded flush with the surface of the moulding.

As the moulding has already been primed, it is ready for painting. Painting may be performed before and/or after installation, as in step 595. If the moulding is painted before installation, touch-up paint may be applied after installation.

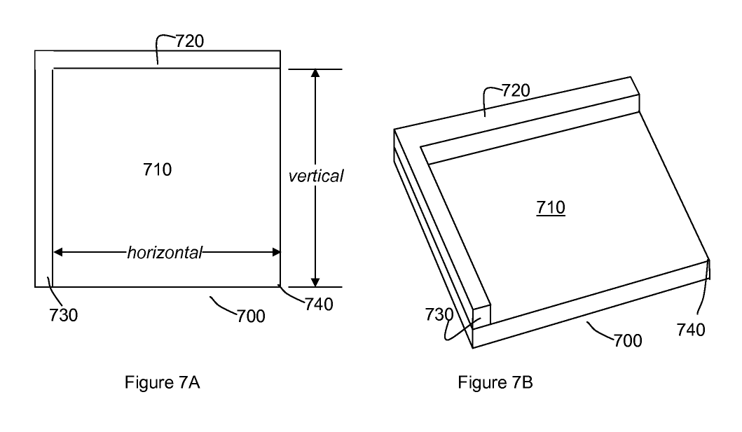

One embodiment of a kit according to principles of the invention may optionally include a measuring and alignment tool tailored for determining a starting point. Referring to FIGS. 7A and 7B, an exemplary measuring and alignment tool 700 is conceptually shown. The tool 700 includes a planar surface 710 with a pair of intersecting raised perpendicular edges 720 and 730. The vertical and horizontal dimensions correspond to the vertical and horizontal measurements for a starting point. Thus, as the raised edges 720 and 730 engage the corner of a door or abut the corner of a wall, the corner 740 opposite the intersection of the raised edges marks the starting point for installing Piece A of the moulding. A kit according to principles of the invention may include one or more of such measuring and alignment tools 700.

While the invention has been described in terms of various embodiments, implementations and examples, those skilled in the art will recognize that the invention can be practiced with modification within the spirit and scope of the appended claims including equivalents thereof. The foregoing is not intended to limit the invention to the exact construction and operation shown and described. Alternative embodiments of the invention, including variations in size, materials, components, shape, form, function, manner of operation, assembly and use that are obvious to one skilled in the art are intended to be encompassed by the invention. Accordingly, all suitable modifications and equivalents may be resorted to, falling within the scope of the invention.

What is claimed is:

1. An on-line ordering and fulfillment system for a moulding decorating kit, comprising:
a user interface, said user interface including
a control for specifying a design,
a control for selecting a moulding type,
a control for specifying a substrate size, and
a module for determining a number of pieces of moulding and a length of each piece of moulding for specified design and substrate size.

2. An on-line ordering and fulfillment system for a moulding decorating kit as in claim 1, said control for specifying a substrate size comprising a dropdown list, said dropdown list including a plurality of determined substrate sizes.

3. An on-line ordering and fulfillment system for a moulding decorating kit as in claim 1, said control for specifying a substrate size comprising a form field into which a user may enter the dimensions of a substrate.

4. An on-line ordering and fulfillment system for a moulding decorating kit as in claim 1, said control for specifying a design comprising a plurality of user-selectable design images.

5. An on-line ordering and fulfillment system for a moulding decorating kit as in claim 1, said control for specifying a design comprising a plurality of user-selectable design names.

6. An on-line ordering and fulfillment system for a moulding decorating kit as in claim 1, said control for specifying a design comprising a plurality of user-selectable images of moulding types.

7. An on-line ordering and fulfillment system for a moulding decorating kit as in claim 1, said control for specifying a design comprising a plurality of user-selectable names of moulding types.

8. A moulding kit for a determined design, moulding type and substrate size, said kit comprising:
a plurality of moulding pieces, said moulding pieces being primed and of a determined type of moulding, and having joint ends, said moulding pieces further being configured to form the determined design on a determined substrate having a determined size; and
attachment means; and
installation instructions.

9. A moulding kit as in claim 8, wherein said attachment means comprises a plurality of nail starter holes in each of said plurality of moulding pieces, and at least one nail per nail starter hole, and said kit further comprises filler.

10. A moulding kit as in claim 8, wherein each of said plurality of moulding pieces includes a back surface, and said attachment means comprises an adhesive applied to the back surface of each of said plurality of moulding pieces.

11. A moulding kit as in claim 8, wherein each of said plurality of moulding pieces includes a back surface, and said attachment means comprises a pressure sensitive adhesive applied to the back surface of each of said plurality of moulding pieces the moulding, and said pressure sensitive adhesive is covered with a releasable backing strip.

12. A moulding kit as in claim 8, wherein each of said plurality of moulding pieces includes a back surface, and said attachment means comprises a bonding agent adapted for application to the back surface of each of said plurality of moulding pieces for attaching each of said plurality of moulding pieces to the substrate.

13. A moulding kit as in claim 8, wherein each of said plurality of moulding pieces is comprised of a material from the group consisting of wood, plastic and foam.

14. A moulding kit as in claim 8, wherein each of said plurality of moulding pieces includes a distinguishing piece identifier.

15. A moulding kit as in claim 8, wherein each of said plurality of moulding pieces includes a first end and a second end and each of said first end and second end include a distinguishing end identifier.

16. A moulding kit as in claim 8, wherein each of said plurality of moulding pieces includes a distinguishing piece identifier, and each of said plurality of moulding pieces includes a first end and a second end, and each of said first end and second end include a distinguishing end identifier.

17. A moulding kit as in claim 8, wherein the joint ends are comprised of a joint end from the group consisting of mitre, butt, butterfly, dovetail, finger, lap, mortise and tenon, rabbet, scarf, splice, and tongue and groove joints.

18. A moulding kit as in claim 8, wherein each of said plurality of moulding pieces includes a back surface, and
said attachment means comprises attachments from the group consisting of
a plurality of nail starter holes in each of said plurality of moulding pieces, and at least one nail per nail starter hole,
an adhesive applied to the back surface of each of said plurality of moulding pieces, and
a pressure sensitive adhesive applied to the back surface of each of said plurality of moulding pieces the moulding, and said pressure sensitive adhesive is covered with a releasable backing strip,
a bonding agent adapted for application to the back surface of each of said plurality of moulding pieces for attaching each of said plurality of moulding pieces to the substrate; and
said plurality of moulding pieces is comprised of a material from the group consisting of wood, plastic and foam.

19. A moulding kit as in claim 18, wherein each of said plurality of moulding pieces includes an identifier from the group consisting of a distinguishing piece identifier and a distinguishing end identifier; and
said joint ends are comprised of a joint end from the group consisting of mitre, butt, butterfly, dovetail, finger, lap, mortise and tenon, rabbet, scarf, splice, and tongue and groove joints.

20. A moulding kit as in claim 18, further comprising a measuring and alignment tool comprising a planar surface, a pair of intersecting raised perpendicular edges extending from a side of the planar surface, wherein the distance from one of the raised perpendicular edges to an opposite edge equals a determined first distance, and the distance from the other of the raised perpendicular edges to an opposite edge equals a determined second distance.
